(19) United States
(12) Patent Application Publication
(10) Pub. No.: US 2018/0289153 A1
(43) Pub. Date: Oct. 11, 2018

(54) Firearm Locking and Restraining System

(71) Applicant: Robert F. Sanchez, Albuquerque, NM (US)

(72) Inventor: Robert F. Sanchez, Albuquerque, NM (US)

(21) Appl. No.: 15/481,293

(22) Filed: Apr. 6, 2017

(51) Int. Cl. A47B 81/00; F41A 17/02

(52) U.S. Cl. CPC A47B 81/005; B60R 7/14; F41A 17/02

(57) ABSTRACT

The present invention is related to a system for locking and/or restraining a firearm, more particularly capturing the muzzle of a long gun such as a rifle, shotgun, or carbine. These are five embodiments to the overall system. The system employs an L-shaped mounting frame; a muzzle restraining controller employing both a manual release capability and an electrical release capability requiring only a signal switching mechanism (solenoid or key) for activation, no additional circuitry is required; a long gun stabilizing bracket; a wall mount bracket; a single or dual long gun stock restraining assembly.

### BACKGROUND OF THE INVENTION

### Field of the Invention (Technical Field)

The present invention is related to a system for locking and/or restraining a firearm, so as only the designated official/operator may have use of the long gun. This is accomplished by more particularly capturing the muzzle of a long gun such as a rifle, shotgun, or carbine as well as capturing the stock of the weapon thereby eliminating any possible removal of the weapon until it is unlocked.

### Background Art

Note that the following discussion may refer to several publications and references. Discussion of such publications herein is given for more complete background of the scientific principles and is not to be construed as an admission that such publications are prior art for patentability determination purposes.

Currently, in locations such as the vehicles of various policing and security agencies, long guns are required to be restrained so that these weapons can only be used by their official operators. These weapons (long guns) are typically locked and restrained using a gripper mechanism attached to a mount fixed to the vehicles chassis. This gripper mechanism typically grasps and restrains the weapon by grasping the barrel and/or fore-stock of the weapon. this method of restraint is becoming increasingly difficult to employ, since users are attaching advanced technologies as scopes, lights, night vision FLIR (Forward-Locking Infrared) technology, etc. to the barrel. This reduces the area available for the gripper to restrain and lock the weapons barrel efficiently. Furthermore, in typical systems the operator must hold the weapon while he or she is releasing it from restraint, which can be extremely difficult or even inconvenient at certain times.

### References Cited

| | | |
|---|---|---|
| 4,747,280 | May 1988 | Shaw |
| 7,188,560 | March 2007 | Regis |
| 8,950,596 | February 2015 | Arabian, Dunn |
| 6,986,446 | January 2006 | Murray, Bounds |
| 7,137,511 | November 2006 | Crowell, Lindebak |
| 4,615,548 | October 1985 | McGee |
| 4,426,864 | January 1984 | Morikawa |
| D376,970 | December 1996 | Drake |
| 4,651,544 | March 1987 | Hungerford |
| 6,742,687 | June 2004 | Morford |
| 6,330,815 | December 2001 | Duncan |

### SUMMARY OF THE INVENTION (DISCLOSURE OF THE INVENTION)

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated and form a part of the specification, illustrate the practice of embodiments of the present invention and, together with the description, serve to explain the principles of the invention. The drawings are only for the purpose of illustrating certain embodiments of the invention and not to be construed as limiting the invention.

In the drawings:

FIG. 1 is a side view perspective of a long gun being restrained by the Muzzle Lock and Stock assembly;

FIG. 2 is a side view perspective of a long gun unrestrained free to be used by the operator;

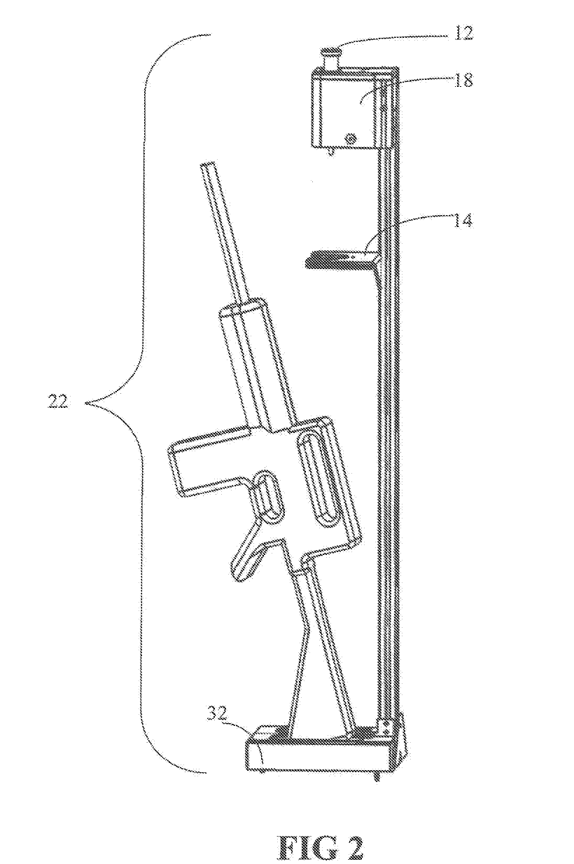

FIG. 3 is an exploded view of the Muzzle Lock;

FIG. 4 is an exploded view of the Key operated Release system;

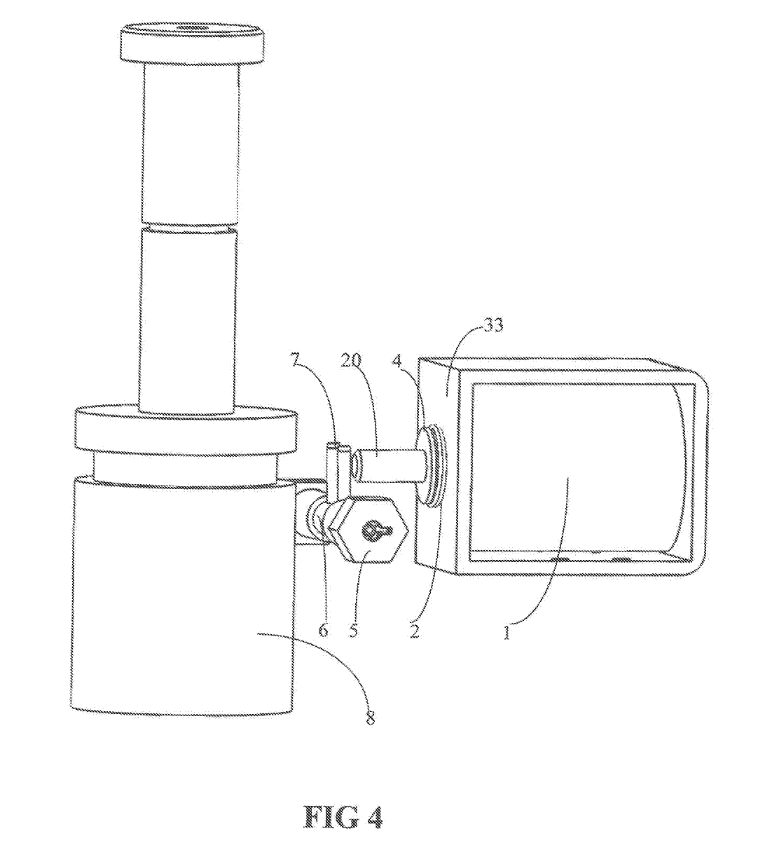

FIG. 5 is an Isometric view of the Stock Assembly;

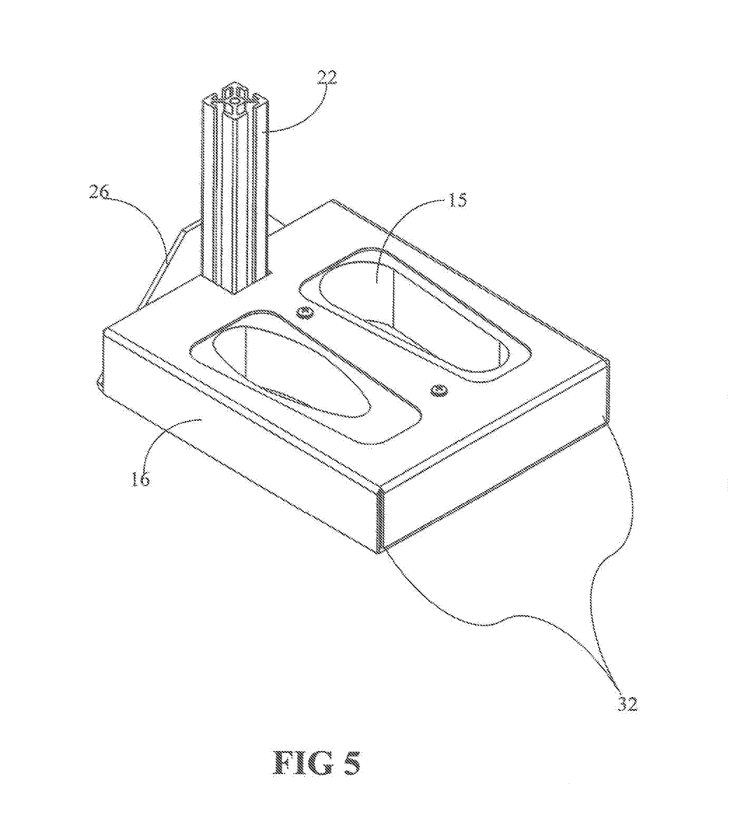

FIG. 6 is a sectional view depicting the Inverted Centering Cone as it is found within the cavity of the Muzzle Restraint;

### DETAILED DESCRIPTION OF EMBODIMENTS OF THE INVENTION

A long gun locking system comprised of a muzzle lock which prohibits a weapon from being removed by anyone other than the operator.

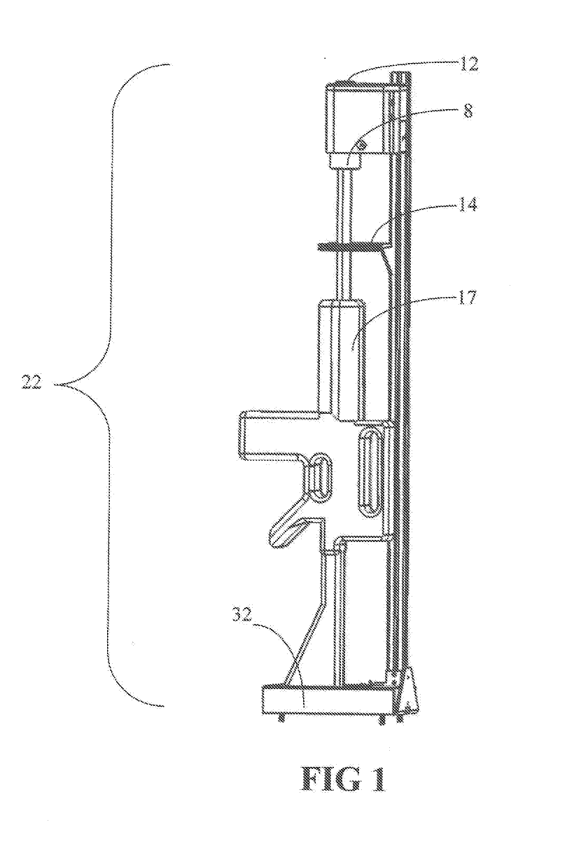

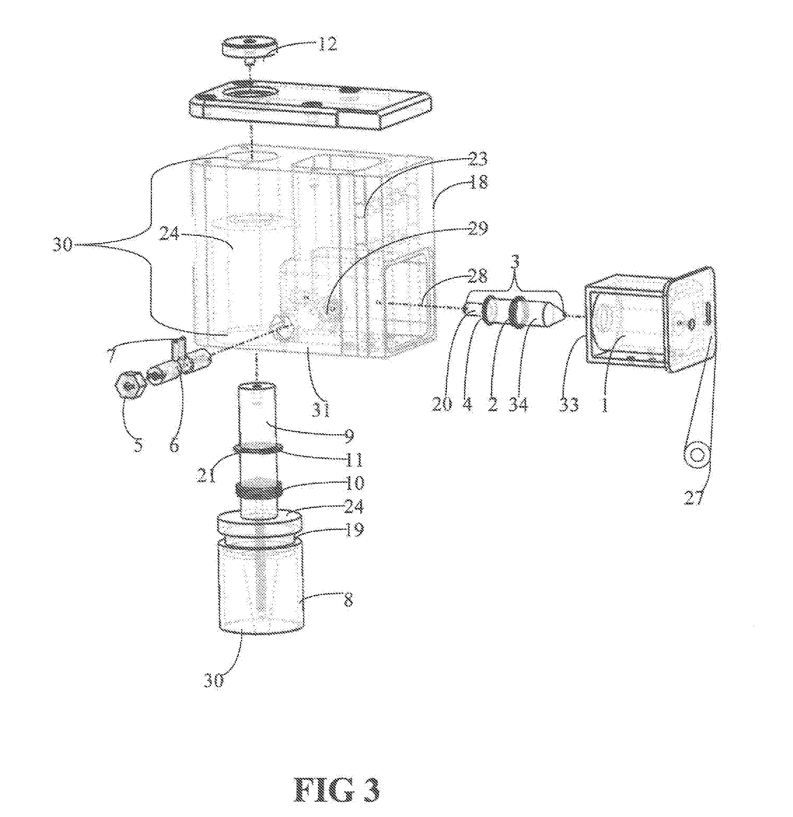

The operator preferably in FIGS. 3 & 4, throws a switch 27 which activates the system Solenoid 1 located within the Solenoid Cavity 28 which then retracts the Actuator Rod 3 located within the Actuator Cavity 29 and comprised of an Actuator Rod Body 34, an Actuator Rod Spring 2, an Actuator Rod Plate 4, and an Actuator Rod Tip 20 compressing the Actuator Rod Spring 2 between the Rod Actuator Plate 4 and the Solenoid Housing Front Plate 33. This retraction, pulls the Actuator Rod Tip 20 axially from the Muzzle Restraint Groove 19 located on and part of the Muzzle Restraint 8 releasing the Muzzle Restraint 8 located within the Muzzle Restraint Cavity 30 thus allowing the compressed Muzzle Restraint Shaft Spring 10 which was compressed between the Muzzle Restraint Housing Ledge 24 located on and part of the Muzzle Restraint 8 and the Muzzle Restraint Shaft Spring Stop 11 which is pressed into the Shaft Spring Stop Groove 21 to decompress driving the Muzzle Restraint 8 upward freeing the firearms muzzle. The operator may then pull the weapon forward and upward laterally freeing it from the Stock Assembly FIGS. 1 2 & 5 32 comprised of having an open cavity in the shape of the cross-section of the stock end of a long gun cut from a Capturing Material 15 which is captured between a Top Cover Plate 16 and a Bottom Mounting Plate 26 and then removed laterally from the Barrel Maintenance Hold Clip FIGS 1 & 2 14 freeing the weapon for use.

The embodiment of this invention, is largely passive allowing for the springs to do the heavy lifting. Employing this unique design, the solenoids duty cycle is extremely short. Thus, allowing for the energized time of the solenoid to be functionally instantaneous. This then creates an extremely minute change for solenoid failure due to overheating

The afore mentioned method of muzzle release varies widely from other systems which employ the barrel capturing method Ref. 8,950,596 B2. In these systems, when a firearm needs removal from its mounting system, a switch is actuated, which then activates the solenoid to release the locked gripper mechanism allowing for the firearm to be removed. However, if the firearm is not removed immediately, this delay could allow the solenoid to overheat causing system failure. To compensate, a delay or time out circuit Ref. 4,747,280 is introduced allowing for a relatively short period of time for the operator to extract the weapon from the gripper. Which if time out is reached before the weapon is removed, the sequence would require a second initiation.

To place the inventions restraining system in locked mode;

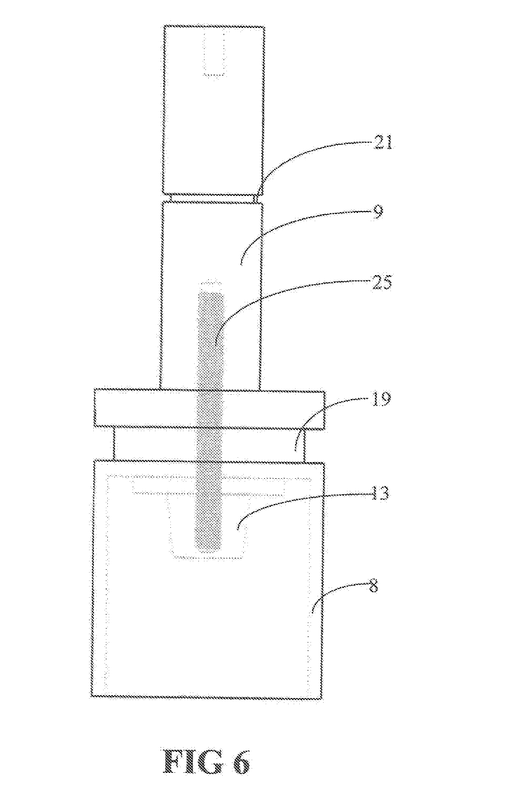

The operator inserts the firearm into the stock Assembly FIGS. 1 2 & 5 32 then guides the weapon in the direction of the Mounting Frame 22 and inserts it into the Barrel Maintenance Hold Clip 14 FIGS. 1&2 which maintains the weapons bore in a vertical position so as to easily accept the Muzzle Restraints 8 Inverted Centering Cone FIG. 6 13 (discussed later in this text). The operator then depresses preferably with his or her palm on the Muzzle Restraint Knob FIGS 1,2,&3 12, compressing the Muzzle Shaft Spring FIG. 3 10, until the Muzzle Restraint Groove FIGS. 3&6 19 is aligned and captured axially by the Actuator Rod Tip 20. The compressed Actuator Rod Spring 2 then decompresses, forcing the Actuator Rod Tip 20 into the Muzzle Restraint Groove 19. As shown in FIG. 1, the Muzzle Restraint 8 is now in place to surround the firearms muzzle, locking the firearm in place on the Mounting Frame 22.

Embodiments of the Muzzle Restraint 8 are the Inverted Centering Cone 13 FIG. 6 which is mounted vertically and concentrically to the Muzzle Restraint 8 using a Threaded Rod 25 fastener threaded into the Muzzle Restraint Shaft 9 so as to provide a centering means of the weapon on the Mounting Frame 23 disallowing the firearm bore contact with the Muzzle Restraint Cavity FIG. 3 30 of the Muzzle Restraint 8 The conical shape of this embodiment allows for the capture of varying weapon bore sizes.

In the event of system power interruption, a Keyed Operated Release located with the Keyed Operated Release Cavity FIG. 3 31 employing both a neutral and release positons and comprised of two primary components, the EMREL A 5 FIGS. 3 & 4 component located on either side of the System Housing 18 which first receives the key, the EMREL “B”π6 FIGS. 3 & 4 component which further comprises 2 (two) Activator Pins 7 FIGS. 3 & 4 mounted vertically on its narrow cylindrical surface. These pins when the key is turned in the release direction, contacts the Rod Actuator Plate 4 which pulls the Actuator Rod Tip 21 axially from the Muzzle Restraint Grove 20, thereby compressing the Actuator Rod Spring 2 and allowing the system to operate as previously stated in the electrically operated embodiment. An alternative means of affecting the same action is the use of a push button barrel lock system (not shown).

Embodiments of the restraining system of the present invention preferably comprises a Self Aligning Boss Structure FIG. 3 23 machined into the Housing 18 which then preferably aligns with Mounting Frame FIGS. 1,2, & 5 22 structure and then screwed into a floating nut (not shown) within the frame.

In the previously stated embodiments of the invention, a mounting frame having a top end and a bottom end, wherein the muzzle lock is attached to the mounting from top such that the axis of the muzzle restraint aligns vertically above the axis of the muzzle end of a long gun and the stock assembly is attached to the mounting frame bottom end such that the stock assembly captures the stock-end of a long gun. Although the invention has been described in detail with particular reference to disclosed embodiments, other embodiments can achieve the same results. Variations and modifications of the present invention will be obvious to those skilled in the art and intended to cover all such modifications and equivalents. The entire disclosures of all patents cited above are hereby incorporated by reference. This system may be configured to unlock and/or lock only in the presence of a preapproved security credential, such as that provided by a magnetic card, smart chip, near field communication, Bluetooth transmitter, or biometric sensor by the addition of additional electronic circuitry (not shown).

What is claimed is:

1. A long gun locking system comprising:
a muzzle lock;
a stock assembly having an open cavity is the shape of the cross-section of the stock end of a long gun; and
amounting frame having a top end and a bottom end, wherein the muzzle lock is attached to the mounting frame top end such that the axis of the muzzle lock aligns vertically above the axis of the muzzle end of a long gun and the stock assembly is attached to the mounting frame bottom end such that the stock assembly captures the stock-end of a long gun.

2. the long gun locking system of claim 1, wherein the muzzle lock further comprises an electrically-operated solenoid.

3. The long gun locking system of claim 1, wherein the muzzle lock further comprises an inverted centering cone for centering the muzzle-end of a long gun.

4. A long gun locking system comprising:
a muzzle lock, further comprising a housing having a muzzle restraint cavity, an adjacent actuator rod cavity, and a key operated release cavity, a muzzle restraint located within the muzzle restraint cavity, an actuator rod located within the actuator rod cavity, the actuator rod in communication with the muzzle restraint, wherein the actuator rod further comprises a neutral position and a release position, and a key-operated release having a neutral position and a release position, the key-operated release located within the key-operated release cavity, wherein the key-operated release is in communication with the actuator rod;
a stock assembly comprising an open cavity in the shape of the cross-section of the stock-end of a long gun; and
a mounting frame having a top end and a bottom end, wherein the muzzle lock is attached to the mounting frame top such that the axis of the muzzle restraint aligns vertically above the axis of the muzzle end of a long gun and the stock assembly is attached to the mounting frame bottom end such that the stock assembly captures the stock-end of a long gun.

5. The long gun locking system of claim 4, wherein the muzzle lock housing further comprises:
a solenoid cavity adjacent to the actuator cavity, and
an electrically-operated solenoid within the solenoid cavity,
wherein the electrically-operated solenoid is in communication with the actuator rod.

6. The long gun locking system of claim 4, wherein the muzzle restraint further comprises an inverted centering cone for centering the muzzle-end of a long gun.
